(19) United States
(12) Patent Application Publication
(10) Pub. No.: US 2014/0190588 A1
(43) Pub. Date: Jul. 10, 2014

(54) VORTEX FILL

(71) Applicant: Agility Fuel Systems, Inc., Fontana, CA (US)

(72) Inventors: Todd F. SLOAN, Kelowna (CA); Chris FORSBERG, Kelowna (CA); Christopher E. CANNON, Alexandria, AL (US)

(73) Assignee: Agility Fuel Systems, Inc., Fontana, CA (US)

(21) Appl. No.: 14/150,126

(22) Filed: Jan. 8, 2014

Related U.S. Application Data
(60) Provisional application No. 61/750,229, filed on Jan. 8, 2013.

(51) Int. Cl. B60K 15/04; B67D 7/04

(52) U.S. Cl. CPC B60K 15/04; B67D 7/04
USPC 141/1; 220/562

(57) ABSTRACT

Improved methods, systems, and devices for filling fuel tanks, particularly compressed natural gas (CNG) fuel tanks, are provided. Such methods, systems, and devices lower the heat of compression when the fuel tank is being filled to a temperature lower than that if such methods, systems, and devices were not used. Pressure sensor logic on a fuel station will be less prone to error, enabling the tank to be filled more accurately and fully. To lower heat of compression, an insert is placed within the tank. The insert changes the flow characteristics of the fuel that is being delivered into the tank. Typically, the delivered fuel will be released into the interior of the tank in a vortex fashion to fill the tank. Other flow modification devices are also provided including an externally coupled Ranque-Hilsh vortex tube and a flow modification chamber built within a fuel tank.

### CROSS-REFERENCE

This application claims priority to U.S. Provisional Patent Application Ser. No. 61/750,229, filed on Jan. 8, 2013, which is entirely incorporated herein by reference.

### BACKGROUND OF THE INVENTION

Natural gas is a consideration as an alternative fuel for vehicles. In a natural gas-powered vehicle, a container or fuel tank is used to hold and transport the natural gas for the vehicle. Such tanks need to be refilled. In many instances, these tanks should be filled to an optimal, maximum capacity to optimize the range of a natural gas-powered vehicle.

To detect whether a tank has been fully filled, a fuel station typically has pressure control logic that stops the filling of the tank when pressure within the tank has reached a threshold level, typically 3,600 psi. In at least some instances, the tank absorbs heat due to heat of compression when a fuel tank is filled with natural gas. This heat may cause the pressure control logic on the fuel station to shut down as if the pressure within the tank were at the threshold level, e.g., 3,600 psi. Once the tank cools, the pressure in the tank can drop by hundreds of psi and reduce driving range for the customer. In other words, in current methods of filling a natural gas tank, heat of compression while filling can cause the pressure control logic to misreport the pressure within the tank such that it is filled below its optimal, maximum capacity. To compensate, some fast-fill type compressed natural gas fuel stations may fill a fuel tank to 4,300 psi to over pressurize the tank before the tank cools down so that pressure settles to 3,600 psi. Over-pressurization, however, is less than ideal in many circumstances. Thus, there is a need for improved methods, systems, and devices for filling fuel tanks, particularly natural gas fuel tanks

### SUMMARY OF THE INVENTION

Aspects of the invention provide improved methods, systems, and devices for filling fuel tanks In particular, improved methods, systems, and devices are provided for reducing heat of compression as a fuel tank is being filled. According to many embodiments, such heat of compression can be reduced by separating fuel input into a cooled fuel stream and a warmer fuel stream or by modifying the flow characteristics of the fuel as it is released into the interior of the fuel tank. By reducing heat of compression, the pressure control logic on a fuel filling station will be able to make more accurate pressure readings for the pressure within the fuel tank. Accordingly, the fuel tank can be filled to its optimal, maximum capacity or improved, increased capacities, increasing the driving range of the vehicle. Such methods, systems, and devices are particularly suitable for compressed natural gas (CNG) and compressed natural gas (CNG) fuel tanks but may also be suitable for other fuels, including liquefied natural gas (LNG), liquefied petroleum gas (LPG), Diesel fuel, gasoline, dimethyl ether (DME), methanol, ethanol, butanol, Fischer-Tropsch (FT) fuels, hydrogren or hydrogen-based gas, hythane, HCNG, syngas, and/or other alternative fuels of fuel blends, and their fuel tanks.

An aspect of the invention provides a method of filling a fuel tank. A fuel tank comprising a fuel inlet and defining a hollow interior for fuel storage is provided. Fuel is delivered past the fuel inlet, through a flow modification element, and into the hollow interior of the fuel tank to fill the fuel tank. The flow modification element causes the fuel tank to be filled such that heat of compression while filling with the flow modification element is less than heat of compression while filling without the flow modification element. Typically, the flow modification element will direct the delivered fuel to flow in a vortex manner within the fuel tank. The delivered fuel will typically be compressed natural gas (CNG) and the fuel tank may be a compressed natural gas (CNG) tank.

The flow modification element may be integral with the fuel tank or comprise an insert that is to be placed within the hollow interior of the fuel tank. Where the flow modification element is integral with the fuel tank, the flow modification element may comprise one or more channels configured to direct the delivered fuel to flow in a vortex manner within the fuel tank. These one or more channels will typically be at least partially helical. Where the flow modification element comprises an insert, the insert may comprise a fuel inlet adapted to couple to the fuel inlet of the fuel tank and a fuel outlet for releasing fuel into the hollow interior of the fuel tank to fill the fuel tank. The insert may comprise at least one of a straight tube, a helical tube, a twisted tape, and a helical vane. The flow modification element may also be an external component that is coupled to the fuel inlet of the fuel tank. For example, the external component may be a Ranque-Hilsh vortex tube adapted to be coupled to the fuel inlet of the fuel tank. This Ranque-Hilsh vortex tube may be configured to separate a stream of fuel into a cooled stream that is delivered into the fuel tank to fill the tank and a warmer stream that is delivered back to the fuel station, a separate fuel cooling device, or the like.

Another aspect of the invention provides a system for storing fuel. The system comprises a fuel tank and a flow modification instrument. The fuel tank comprises a fuel inlet and defines a hollow interior for fuel storage. The flow modification element is adapted to be coupled to the fuel tank. When the fuel tank is filled, the flow modification element causes the fuel tank to be filled such that heat of compression while filling with the flow modification element coupled to the fuel tank is less than heat of compression while filling without the flow modification element. The fuel tank may specifically be adapted to store compressed natural gas (CNG) and be a compressed natural gas (CNG) tank.

The flow modification element may be an insert adapted to be placed within the fuel tank. The insert comprises a fuel inlet end and a fuel outlet end. The fuel inlet end is adapted to couple to the fuel inlet of the fuel tank and the fuel outlet end releases fuel into the interior of the fuel tank to fill the fuel tank. The insert may comprise at least one of a straight tube, a helical tube, a twisted tape, and a helical vane. The flow modification element may also be a Ranque-Hilsh vortex tube as described above.

A further aspect of the invention provides a fuel tank comprising a fuel inlet, a fuel storage chamber, and a flow modification element. The flow modification element is disposed between the fuel inlet and the fuel storage chamber. When the fuel tank is filled, the flow modification element causes the fuel tank to be filled such that heat of compression while filling the flow modification element is less than heat of compression while filling without the flow modification element. The flow modification element will typically be integral with the fuel tank. Alternatively, the flow modification element may be a separate component that is coupled to the interior of the fuel tank. The flow modification element may comprise one or more channels configured to direct fuel delivered from the fuel inlet to flow in a vortex manner within the fuel storage chamber. These channels may be at least partially helical. Typically, the fuel tank comprises a compressed natural gas (CNG) tank.

Additional aspects and advantages of the disclosure will become readily apparent to those skilled in this art from the following detailed description, wherein only illustrative embodiments of the present disclosure are shown and described. As will be realized, the present disclosure is capable of other and different exemplary implementations, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a perspective view of a fuel tank with a section cut out for the purpose of illustration.

FIG. 1B is a cross-sectional view of the fuel tank of FIG. 1A.

FIG. 2 is a graph showing the temperature profile of a fuel tank as it is being filled.

FIG. 3 is a cross-sectional view of a fuel tank coupled with a fuel flow modification insert according to various embodiments.

FIG. 4 is a graph showing the temperature profile of a fuel tank coupled with a fuel flow modification insert as the tank is being filled;

FIG. 5A is a side view of a helical flow modification insert according various embodiments.

FIG. 5B is a cross-sectional view of a fuel tank coupled with a helical flow modification insert.

FIG. 5C is a side view of another helical flow modification insert according to various embodiments.

FIG. 6A is a cross-sectional view of a fuel tank coupled with a flow modification insert having a flow modification portion according to various embodiments.

FIG. 6B is a side, cross-sectional view of a flow modification portion (e.g., of FIG. 6A) comprising a twisted tape according to various embodiments.

FIG. 6C is a side, cross-sectional view of a flow modification portion (e.g., of FIG. 6A) comprising a screw winding according to various embodiments.

FIG. 6D is a side, cross-sectional view of a flow modification portion (e.g., of FIG. 6A) comprising a static mixer according to various embodiments.

FIG. 7 is a cross-sectional view of a fuel tank coupled with a Ranque-Hilsh vortex tube according to various embodiments.

FIG. 8 is a cross sectional view of a fuel tank having an internal fuel flow modification structure according to various embodiments.

### DETAILED DESCRIPTION OF THE INVENTION

Aspects of the invention provide improved methods, systems, and devices for filling fuel tanks In particular, improved methods, systems, and devices are provided for reducing heat of compression as a fuel tank is being filled. Various aspects of the invention described herein may be applied to any of the particular applications set forth below or for any other types of gaseous fuel monitoring systems. Aspects of the invention may be applied as a standalone system or method, or as part of a vehicle, vehicle fuel tank, or other system that utilizes gaseous or other fuel. Such vehicle fuel tanks include those mounted on vehicles, such as cars, wagons, vans, heavy duty vehicles, buses, high-occupancy vehicles, dump trucks, tractor trailer trucks, or other vehicles. The fuel tank may be mounted in many ways including but not limited to side mounting, roof mounting, and rear mounting. According to embodiments of the invention, these fuel tanks may be filled while mounted on the vehicle or filled before being mounted on the vehicle. It shall be understood that different aspects of the invention can be appreciated individually, collectively, or in combination with each other.

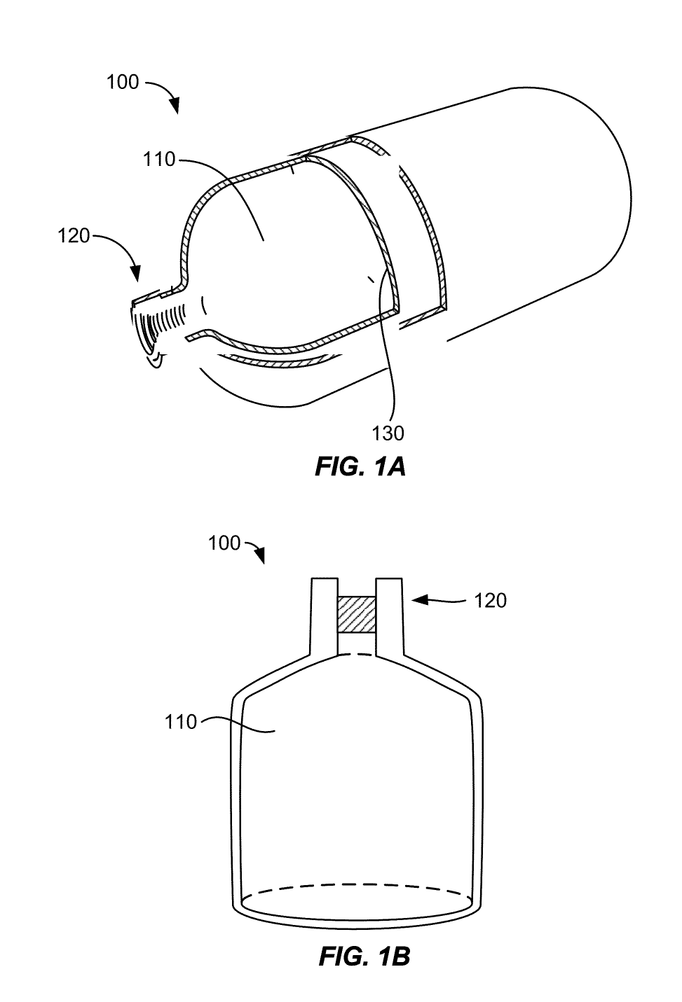

FIG. 1A is a perspective view of a fuel tank 100 with a section cut out for the purpose of illustration. The fuel tank 100 is configured to be filled with and store compressed natural gas (CNG). The fuel tank 100 may also be instead configured to be filled with other fuels such as liquefied natural gas (LNG), liquefied petroleum gas (LPG), Diesel fuel, gasoline, dimethyl ether (DME), methanol, ethanol, butanol, Fischer-Tropsch (FT) fuels, hydrogren or hydrogen-based gas, hythane, HCNG, syngas, and/or other alternative fuels of fuel blends. Where the filled fuel is gaseous, the fuel tank may be capable of containing a fuel having less than or equal to about 10000 psi, 8000 psi, 7000 psi, 6000 psi, 5500 psi, 5000 psi, 4750 psi, 4500 psi, 4250 psi, 4000 psi, 3750 psi, 3500 psi, 3250 psi, 3000 psi, 2750 psi, 2500 psi, 2000 psi, 1500 psi, 1000 psi, 500 psi, 300 psi, 100 psi, or less.

As shown in FIG. 1A, fuel tank 100 is cylindrical and comprises a hollow interior 110, a fuel inlet element 120, and a reinforced, insulated wall 130. The wall 130 is built to withstand high pressures when the tank 100 is filled with compressed natural gas as well as to maintain the temperature of the stored fuel. The fuel tank inlet element 120 is adapted to be coupled with fuel sources such as the typical fuel filling pumps, particularly CNG filling pumps, found in fuel stations. FIG. 1B shows a cross-sectional view of the fuel tank 100, emphasizing the hollow interior 110 which stores the fuel delivered into the tank 100.

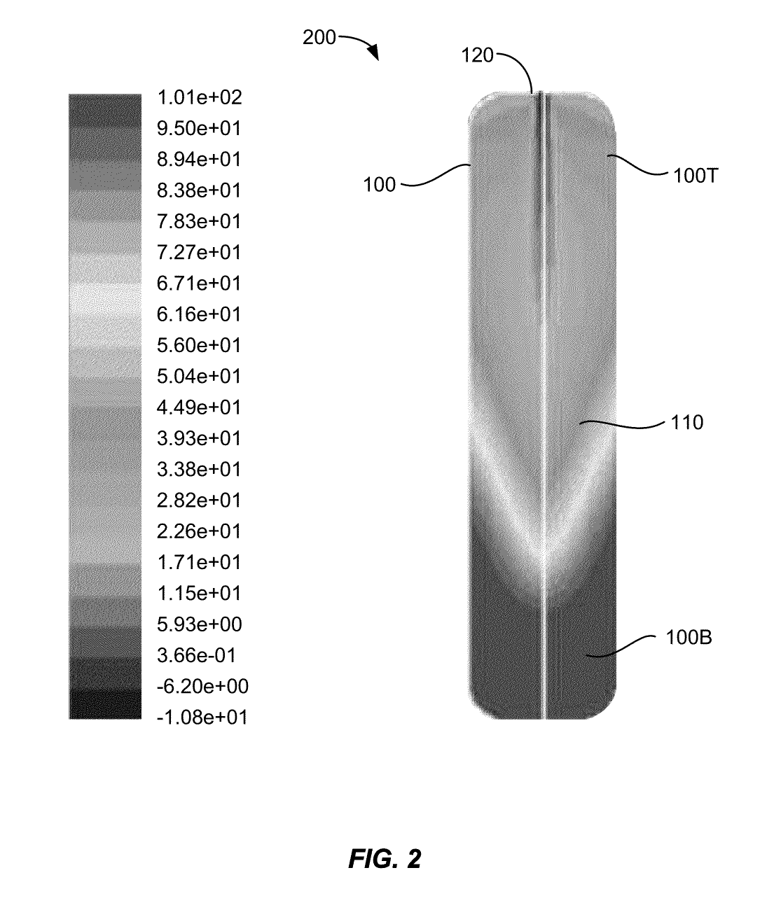

FIG. 2 is a graph 200 showing the temperature profile of the fuel tank 100. As shown in the graph 200, fuel is released into the interior 110 of the fuel tank 100 from an opening in the fuel inlet element 120 at the top portion 100T of the tank 100 as in many current conventional methods. Initially for a relatively unfilled tank 100, natural gas released from the fuel inlet element 120 decreases in temperature because it is released into the lower pressure environment of the interior 110 from a higher pressure, compressed environment from the fuel station pump. As the tank 100 starts becoming more filled, it becomes more pressurized and the temperature of the gas within the fuel tank 100 may increase, starting with the bottom portion 100B of the tank as shown in graph 200. This heat of compression often causes the pressure control logic on a fuel station or a fuel station pump to report inaccurate readings, particularly inaccurate readings of the amount of fuel delivered into the tank 100. For example, a fuel tank 100 that has an optimal capacity of 3,600 psi may be filled up to when pressure in the tank reaches 3,600 psi. As the fuel in the tank 100 returns to a normal, vehicle operating temperature, pressure will often drop by hundreds of psi. This drop in psi means that the tank 100 was filled below capacity even if the pressure control logic otherwise showed that the tank 100 was filled to capacity. Accordingly, a vehicle using the fuel tank 100 filled with this method may often be driving with a less than optimal and less than maximum range.

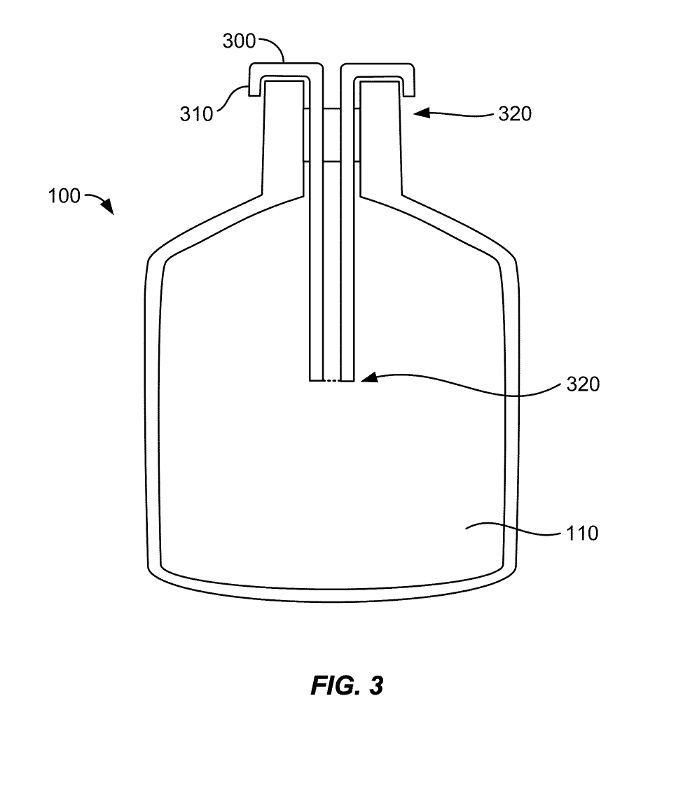

Aspects of the invention provide methods, systems, and devices for filling fuel tanks that reduce this heat of compression. FIG. 3 is a cross-sectional view of the fuel tank 100 coupled with a fuel flow modification insert 300. The fuel flow modification insert 300 may comprise a long, cylindrical tube. The fuel flow modification insert 300 may be configured in other ways, such as by having an elliptical, triangular, rectangular, square, or other polygonal cross-section. Passage through the insert 300 lengthens the flow path for the fuel and can increase the laminar quality of the flow.

The insert 300 can be coupled to the fuel inlet element 120 at top portion 310. For example, the fuel inlet element 120 and the top portion 310 may both comprise threads such that the fuel flow modification insert 300 may be screwed onto the fuel inlet element 120. The insert 300 may also couple to the fuel tank 100 in various other ways such as by using snap fasteners or friction locking mechanisms. The top portion 310 of the insert 300 can also couple to a fuel filling pump. The fuel flow modification insert 300 ends at an opening 320. Fuel is released into the interior 110 of the tank 100 at the opening 320 which as shown in FIG. 3 is positioned in the middle of the interior 110 of the tank 100. In some instances, the opening may be disposed at other locations in the interior 110 of the tank 100, for example about 10%, 20%, 30%, 40%, 60%, 70%, 80%, and 90% of the way into the tank 100.

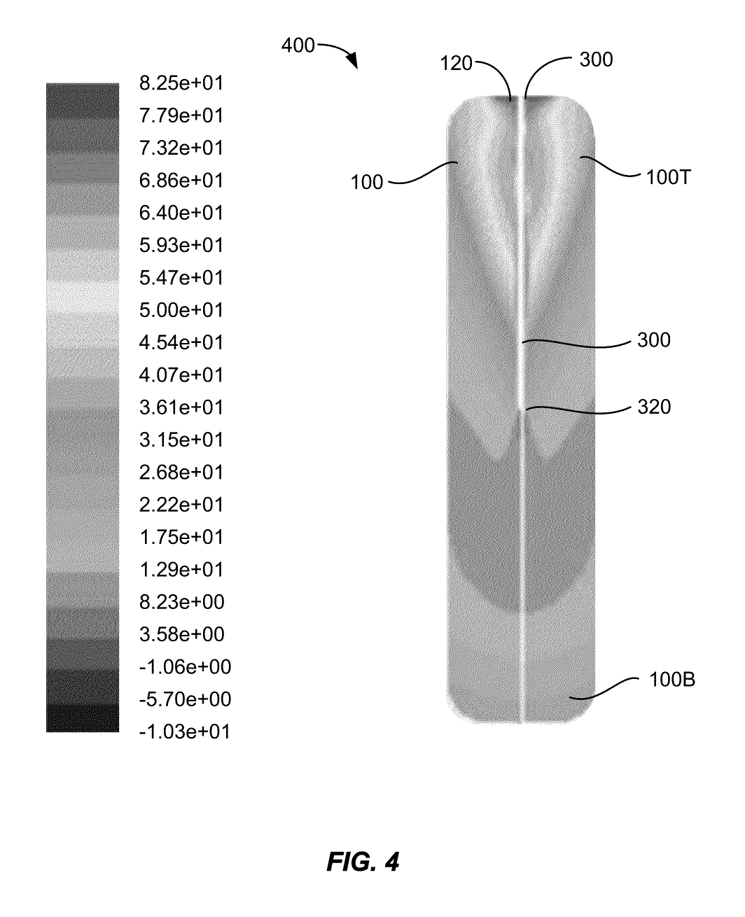

Releasing fuel into the interior 110 of the tank 100 at the middle of the interior 110 of the tank instead of the top 100T may lower heat of compression. FIG. 4 is a graph 400 showing the temperature profile of a fuel tank 100 coupled with the fuel flow modification insert 300 as the tank is being filled. As shown in the graph 400, the temperature of the fuel within the interior 110 is cooler and more uniform where fuel is released from the middle of the interior 110 of the tank versus where the fuel release point is at the top end 110T of the tank 100. Because there is less heat of compression, pressure control logic can more accurately gage the current fuel level of the tank 100 as it is being filled. Thus, a reading that the tank 100 is full will more accurately reflect the fact that the tank 100 is indeed at full capacity once the gas within the tank 100 is at a normal, vehicle operating temperature.

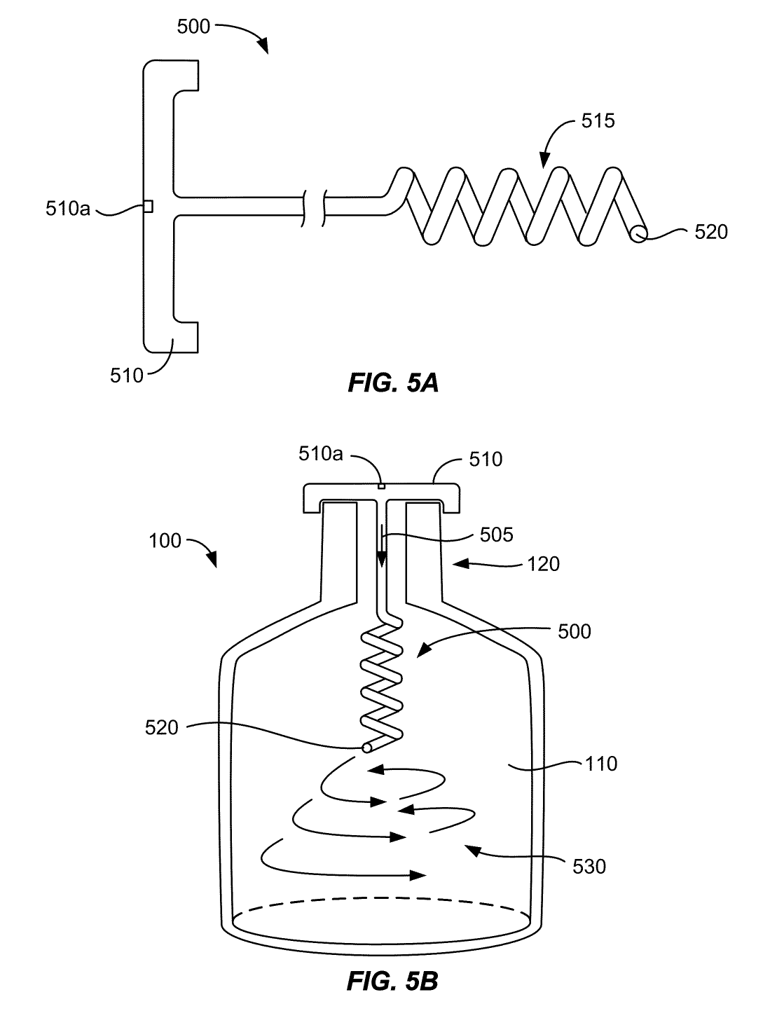

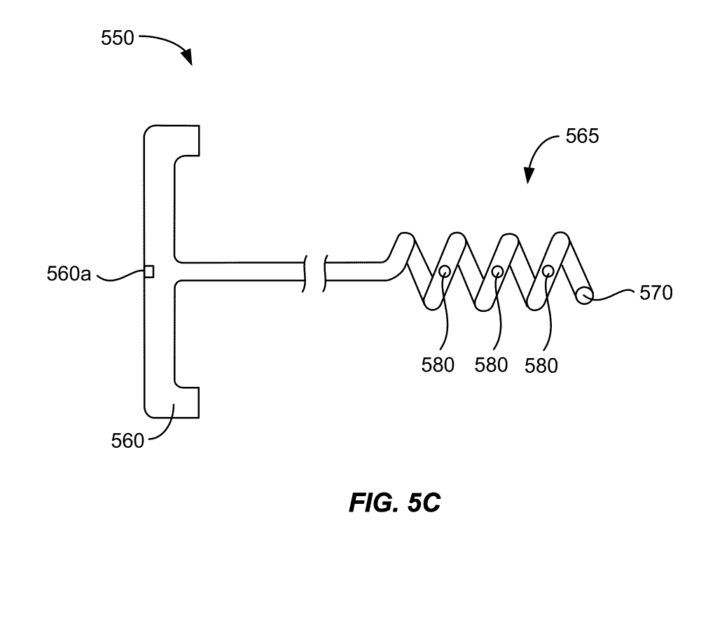

Various other types and arrangements can also be used to lower heat of compression. FIG. 5A is a side view of a helical flow modification insert 500 according various embodiments. The insert 500 can be similar to insert 300 or share one or more common features with insert 300. Instead of comprising a long, straight middle portion, however, the insert 500 comprises a helical portion 515. The insert 500 comprises a top, inlet portion 510 adapted to couple to the fuel inlet element 120 of the tank 100 as shown in FIG. 5B. The insert 500 may couple to the tank 100 by various ways as described above. A fuel pump nozzle may couple to a port 510a in the inlet portion 510 of the insert 500 to introduce fuel into the hollow insert 500 as shown by arrow 505. As the fuel travels through the insert 500, the laminar quality of the fuel flow may increase and the fuel passes through the helical portion 515 and is released at end port 520. The released fuel continues its directionality of movement such that it is released into the interior 110 of the tank in a vortex manner as shown by arrows 530. By having the fuel move in a vortex manner within the tank, there will be substantially less heat of compression than if the fuel were delivered into the tank in a conventional manner. Because there is less heat of compression, pressure control logic can more accurately gage the current fuel level of the tank 100 as it is being filled. Thus, a reading that the tank 100 is full will more accurately reflect the fact that the tank 100 is indeed at full capacity once the gas within the tank 100 is at a normal, vehicle operating temperature. As shown in FIG. 5B, the insert 500 releases fuel at a location about 40% of the way into the interior 110 of the tank 100. The insert 500 may also be configured to release fuel into the interior 110 of the tank 100 at other locations, including not limited to about 10%, 20%, 30%, 50%, 60%, 70%, 80%, and 90% of the way into the tank 100.

FIG. 5C is a side view of another helical flow modification insert 550 according to various embodiments. The helical insert 550 is similar to the helical insert 500 described above. The insert 550 comprises a top, inlet portion 510 adapted to couple to the fuel inlet element 120 of the tank 100, an inlet port 560a in the inlet portion 560, a helical portion 565, and a fuel outlet end port 570. The helical portion 565 further comprises one or more side outlet ports 580 which like fuel outlet end port 570 also release fuel into the interior 110 of the fuel tank 100 in a vortex manner. A plurality of side outlet ports 580 may be spaced away from each other evenly or such that fuel is released from the insert 550 evenly throughout the interior 110 of the fuel tank 100.

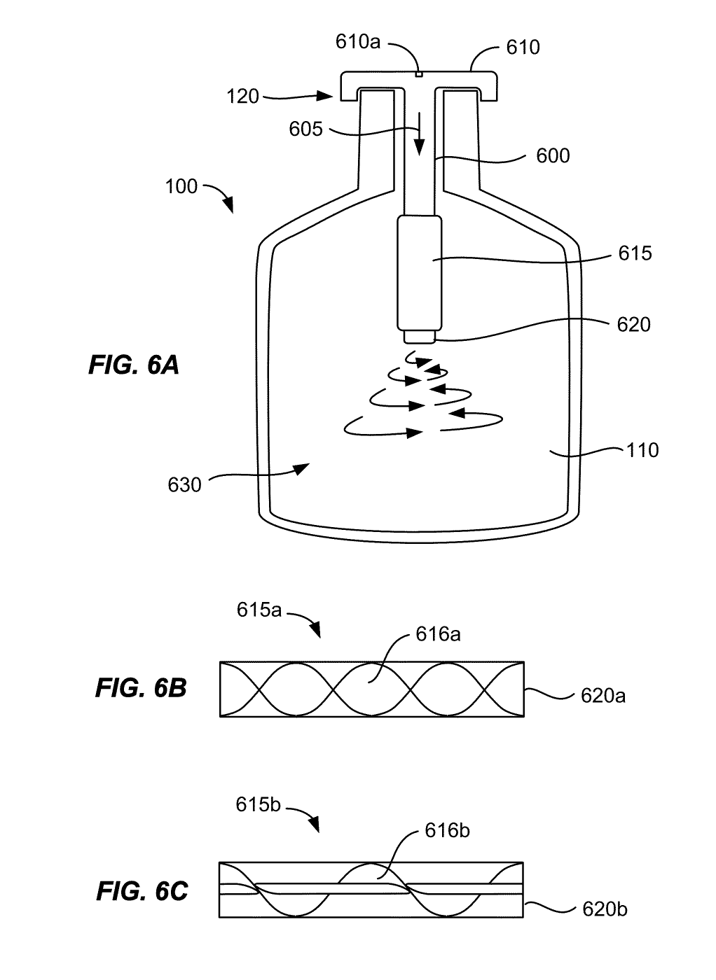

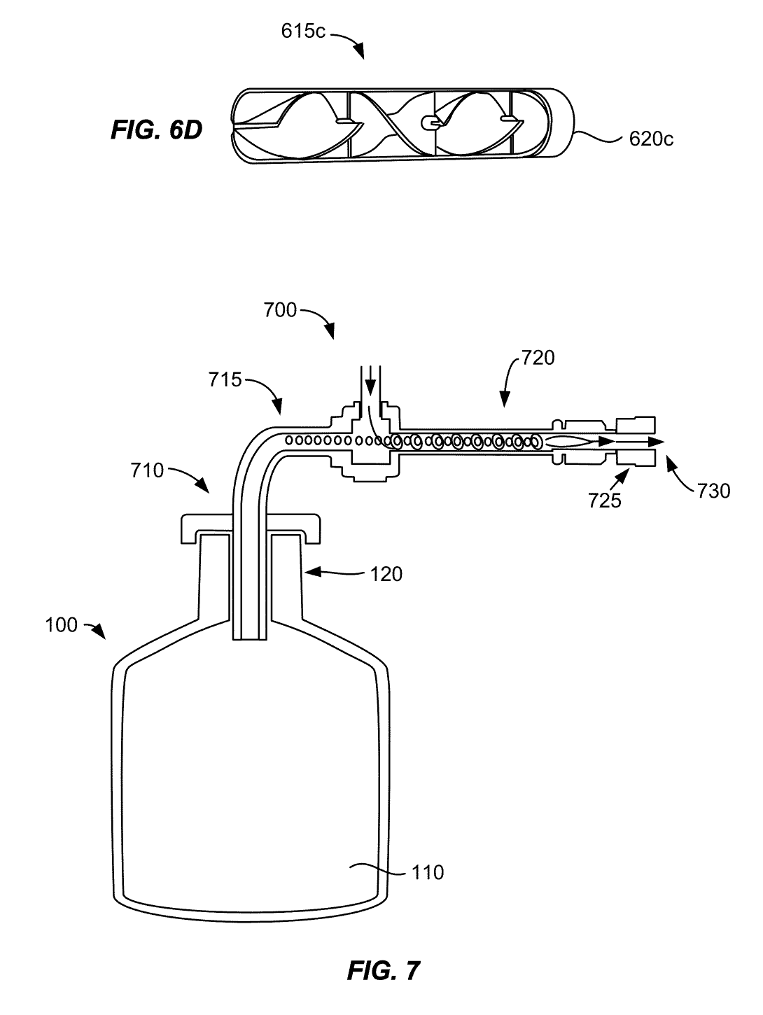

Various embodiments also provide various inserts that also release fuel into the interior 110 of the fuel tank 100 in a vortex manner. As shown in FIG. 6A, the fuel tank 100 may be coupled with a fuel flow modification insert 600. The insert 600 may couple with the fuel tank 100 in many ways. The insert 600 may comprise a top, fuel inlet portion 610 having an inlet port 610a; and, the inlet portion 610 couples to the inlet portion 120 of the tank 100. The insert 600 comprises a flow modification structure 615 which can increase the laminar quality of the fuel and releases fuel into interior 110 of the tank 100 in a vortex manner.

The flow modification structure 615 houses structural elements which modifies the flow characteristics of fuel passing through the structure 615. Some examples of these fuel flow modifying structural elements are shown in FIGS. 6B, 6C, and 6D.

FIG. 6B shows a side, cross-sectional view of a flow modification structure 615a that houses a twisted-tape 616a. The twisted tape 616a causes the straight, laminar flow of fuel passing through the flow modification structure 615a to rotate to some degree. Thus, fuel is released in a vortex manner from outlet port 620a.

FIG. 6C shows a side, cross-sectional view of a flow modification structure 615b that houses a screw winding 616b. The screw winding 616b causes the straight, laminar flow of fuel passing through the flow modification structure 615b to rotate to some degree. Thus, fuel is released in a vortex manner from outlet port 620b.

FIG. 6D shows a side, cross-sectional view of a flow modification structure 615c that comprises a static mixer. As fuel passes through the static mixer, a degree of rotation is added to the straight, laminar flow of fuel. Thus, fuel is released in a vortex manner from outlet port 620b.

According to various embodiments, fuel may be pre-cooled before it is delivered into a fuel tank 100 to reduce heat of compression. For example, a Ranque-Hilsh vortex tube 700 as shown in FIG. 7 may be used to pre-cool fuel delivered into a fuel tank 100. FIG. 700 is a cross-sectional view of the fuel tank 100 coupled with the Ranque-Hilsh vortex tube 700. The vortex tube 700 comprises a fuel outlet portion 710 which can couple to inlet portion 120 of the fuel tank 100. The vortex tube 700 separates fuel flow into a cooled fuel stream 715 and a warmer fuel stream 720. The cooled fuel stream 715 is delivered into the interior of the fuel tank 100. The warmer fuel stream 720 exits the vortex tube 700 at an outlet port 730 and may be delivered to many locations, such as into a cooling device before being fed back into the fuel station tank or back into the vortex tube 700. The vortex tube 700 may further comprise a control valve 725 to control the warm fuel stream output of the vortex tube 700. By having the fuel delivered into the fuel tank 100 pre-cooled, there will be substantially less heat of compression than if the fuel were delivered into the tank in a conventional manner. Because there is less heat of compression, pressure control logic can more accurately gage the current fuel level of the tank 100 as it is being filled. Thus, a reading that the tank 100 is full will more accurately reflect the fact that the tank 100 is indeed at full capacity once the gas within the tank 100 is at a normal, vehicle operating temperature.

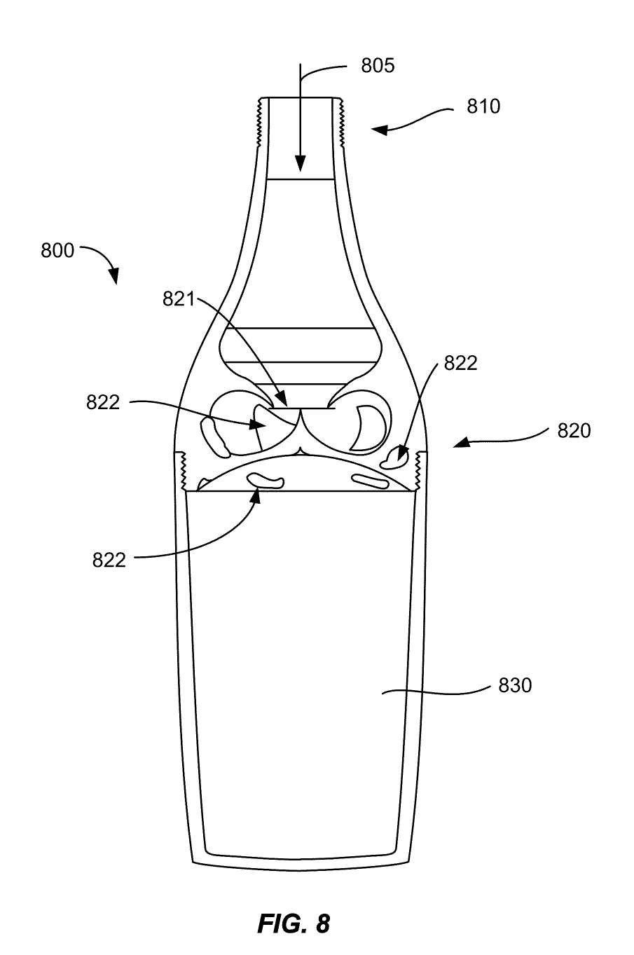

According to various embodiments, a fuel tank itself may carry structures which modify fuel flow to reduce heat of compression. FIG. 8 is a cross sectional view of a fuel tank 800 comprising an internal fuel flow modification structure 820. The flow modification structure 820 may be integral, i,e, built into, the fuel tank 100. The fuel tank 800 comprises a fuel inlet portion 810 which may couple to a fuel station pump or nozzle to deliver fuel into the fuel tank 800 in a direction 811. The fuel tank 800 comprises a fuel storage chamber 830 which stores at least a majority of all the fuel delivered into the fuel tank 800. In order to enter the fuel storage chamber 830, fuel first passes through the flow modification structure 820 which releases fuel into the fuel storage chamber 830 in a vortex manner as described above to reduce heat of compression. The flow modification structure 820 comprises a performer 821 which directs fuel flow into one or more channels 822 of the flow modification structure 820. These one or more channels 822 may be at least partially helical or spiral to re-direct fuel to move in a vortex manner as it exits the fuel modification structure 820 and into the fuel storage chamber 830.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of filling a fuel tank, the method comprising:
providing a fuel tank comprising a fuel inlet and defining a hollow interior for fuel storage; and
delivering fuel past the fuel inlet, through a flow modification element, and into the hollow interior of the fuel tank to fill the fuel tank,
wherein the flow modification element causes the fuel tank to be filled such that heat of compression while filling with the flow modification element is less than heat of compression while filling without the flow modification element.

2. The method of claim 1, wherein the flow modification element is adapted to direct the delivered fuel to flow in a vortex manner within the fuel tank.

3. The method of claim 1, wherein the flow modification element is integral with the fuel tank.

4. The method of claim 3, wherein the flow modification element comprises a channel configured to direct the channeled fuel to flow in a vortex manner within the fuel tank.

5. The method of claim 4, wherein the channel is at least partially helical.

6. The method of claim 1, wherein the flow modification element comprises an insert to be placed within the hollow interior of the fuel tank.

7. The method of claim 6, wherein the insert comprises a fuel inlet end adapted to couple to the fuel inlet of the fuel tank.

8. The method of claim 6, wherein the insert comprises a fuel outlet for releasing fuel into the hollow interior of the fuel tank to fill the fuel tank.

9. The method of claim 6, wherein the insert comprises at least one of a straight tube, a helical tube, a twisted tape, and a helical vane.

10. The method of claim 1, wherein the flow modification element comprises a Ranque-Hilsh vortex tube adapted to be coupled to the fuel inlet of the fuel tank.

11. The method of claim 1, wherein the fuel tank comprises a compressed natural gas (CNG) tank.

12. The method of claim 1, wherein the channeled fuel comprises compressed natural gas (CNG).

13. A system for storing fuel, the system comprising:
a fuel tank comprising a fuel inlet and defining a hollow interior for fuel storage; and
a flow modification element adapted to be coupled to the fuel tank,
wherein when the fuel tank is filled, the flow modification element causes the fuel tank to be filled such that heat of compression while filling with the flow modification element coupled to the fuel tank is less than heat of compression while filling without the insert.

14. The system of claim 13, wherein the flow modification element comprises an insert adapted to be placed within the fuel tank, the insert comprising a fuel inlet end adapted to couple to the fuel inlet of the fuel tank and a fuel outlet end for releasing fuel into the interior of the fuel tank to fill the fuel tank.

15. The system of claim 14, the insert comprises at least one of a straight tube, a helical tube, a twisted tape, and a helical vane.

16. The system of claim 13, wherein the flow modification element comprises a Ranque-Hilsh vortex tube adapted to be coupled to the fuel inlet of the fuel tank.

17. The system of claim 13, wherein the fuel tank comprises a compressed natural gas (CNG) tank.

18. A fuel tank comprising:
a fuel inlet;
a fuel storage chamber; and
a flow modification element disposed within the fuel tank and between the fuel inlet and the fuel storage chamber, wherein when the fuel tank is filled, the flow modification element causes the fuel tank to be filled such that heat of compression while filling with the flow modification element is less than heat of compression while filling without the flow modification element.

19. The method of claim 18, wherein the flow modification element is integral with the fuel tank.

20. The method of claim 18, wherein the flow modification element comprises a channel configured to direct the channeled fuel to flow in a vortex manner within the fuel tank.

21. The method of claim 20, wherein the channel is at least partially helical.

22. The system of claim 18, wherein the fuel tank comprises a compressed natural gas (CNG) tank.
